(19) United States
(12) Patent Application Publication
(10) Pub. No.: US 2008/0295956 A1
(43) Pub. Date: Dec. 4, 2008

(54) METHOD AND DEVICE FOR LAMINATING ESSENTIALLY PLATE-SHAPED WORKPIECES UNDER THE EFFECT OF PRESSURE AND HEAT

(75) Inventors: Norbert Damm, Karlsdorf-Neuthard (DE); Dagmar Metzger, Karlsruhe (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: ROBERT BURKLE GMBH, Freudenstadt (DE)

(21) Appl. No.: 12/129,960

(22) Filed: May 30, 2008

(30) Foreign Application Priority Data
May 30, 2007 (DE) 102007025380.1
Jul. 21, 2007 (DE) 102007034135.2

(51) Int. Cl. B29C 65/02; B32B 41/00

(52) U.S. Cl. 156/285; 156/382; 156/359

(57) ABSTRACT

A method and a device for laminating essentially plate-shaped workpieces 20, 21 with at least one adhesive layer 402 that can be heat activated and cured under the effect of pressure and heat is provided. A number of workpieces 20, 21 is inserted into a multiple-stage vacuum lamination press 200, in which the workpieces 20, 21 are laminated in press stages each with a vacuum chamber divided by a flexible pressure member 30b, 31b, 32b, 150, 151 into a product half 141 and a pressure half 131 under the effect of heat, wherein the product half 141 of the vacuum chamber, in which at least one workpiece 20, 21 is arranged, is evacuated and the pressure member presses the workpiece 20, 21 directly or indirectly against a bottom side of the vacuum chamber due to the resulting low pressure and/or due to an additional pressurization of the pressure half of the vacuum chamber, which is arranged on the side of the pressure member facing away from the workpiece 20, 21. The lamination process is interrupted by opening the multiple-stage vacuum lamination press 200 and the number of pre-laminated workpieces 20, 21 are transferred into a multiple-stage laminator 201, and that the workpieces 20, 21 in the multiple-stage laminator 201 are exposed to a temperature at or above the curing temperature of the adhesive layers.

### CROSS-REFERENCE TO RELATED APPLICATIONS

This application claims the benefit of DE 10 2007 025 380.1, filed May 30, 2007 and DE 10 2007 034 135.2, filed Jul. 21, 2007, which are incorporated by reference herein as if fully set forth.

### BACKGROUND

The invention relates to a method for laminating essentially plate-shaped workpieces under the effect of pressure and heat and also relates to a device for carrying out the method. The workpieces to be laminated in this way have a multiple-layer construction and contain at least one adhesive layer with an adhesive that is heat activated and cured. The preferred field of application of the present invention is the lamination of photovoltaic modules, in which a solar-cell layer is encapsulated with all of its electrical contacting elements in a moisture-tight way and is covered in a weatherproof way that is nevertheless light transmissive.

In the scope of the present invention, a multiple-stage vacuum lamination press is used with several press stages. In each press stage, a vacuum chamber is provided, which is divided by a flexible pressure member into a product half and a pressure half. The product half of the vacuum chamber is provided for receiving at least one workpiece and can be evacuated while the pressure half of the vacuum chamber can be pressurized. The flexible pressure member is equipped and arranged in such a way that it presses the workpiece directly or indirectly against a bottom side of the vacuum chamber due to a pressure difference in the vacuum chamber generated through the evacuation of the product half and/or through additional pressurization of the pressure half.

A multiple-stage vacuum lamination press for laminating photovoltaic modules is described in EP 1 609 597 A2. This lamination press includes a number of heating plates, between each of which a press stage is formed. Above each heating plate, on the bottom side of the heating plate arranged above, there is a sealing frame, which circumscribes a vacuum chamber that can be evacuated for a closed press stage through close contact of the sealing frame on the underlying heating plate. Across the sealing frame, an elastic membrane is tensioned, which divides the vacuum chamber into a product half and a pressure half and which is also used as pressure member, in order to apply the pressure against the heating plate necessary for the lamination of the photovoltaic module. For this purpose, the volume, which lies under the membrane, between this membrane and the heating plate, for a closed press and which forms the product half of the vacuum chamber, is evacuated, by which the membrane contacts close against the workpiece. If necessary, a pressure half of the vacuum chamber, wherein this pressure half is formed by sealing the sealing frame relative to the upper press plate and is limited downward by the membrane, is also loaded with compressed air, in order to increase the contact pressure of the workpiece. The evacuation of the product half allows bubble-free lamination of the workpiece, because any air inclusions and the like are drawn out before reaching the softening temperature of the adhesive being used. Through the contact of the workpiece with the heating plate, the workpiece gradually heats up past the softening temperature and the curing temperature of the adhesive layers, so that the lamination process can be continued up to the complete curing of the adhesive.

The output of electrical energy from photovoltaic modules is directly dependent on the surface area. Accordingly, the processing capacity per unit of surface area for time-fixed processes such as that of the lamination directly influences the cost efficiency in the production of the modules. Therefore, it is advantageous to use a multiple-stage vacuum lamination press, in which multiple press stages are arranged one above the other. In this way, the surface area capacity to be processed increases without increasing the surface area requirements at the production site.

However, due to the multiple-stage configuration of a lamination press, the already high energy requirements in the heating and cooling cycle increase due to the reduced interaction of the individual heating plates with the surroundings. In addition, it is consequently difficult to accommodate the heating and cooling systems necessary for optimum temperature control in the necessary dimensions due to the limited spatial relationships in a multiple-stage lamination press. Finally, with respect to further increased cost efficiency, it is desirable to further reduce the cycle times for the lamination also for the use of a multiple-stage lamination press, which can be performed only within tight limits due to the reasons just mentioned, such that the heating and cooling times are shortened.

### SUMMARY

The present invention is based on the objective of avoiding the above disadvantages in a device as noted above or a method as noted above and to further increase the efficiency of the lamination process.

This objective is met by a method and apparatus according to the invention.

Preferred configurations of the method according to the invention and the device according to the invention are set forth in more detail below.

The present invention distinguishes itself in that at least one multiple-stage laminator is arranged after the multiple-stage vacuum lamination press. This laminator includes a number of laminator stages, in which the workpieces are subject to a temperature at or above the curing temperature of the adhesive layers. For transferring the workpieces from the multiple-stage vacuum lamination press to the one or more multiple-stage laminators, a transfer device is provided. In the simplest case, this transfer device can be formed in such a way that both the multiple-stage lamination press and also the multiple-stage laminator are provided in each stage with a conveyor belt for feeding and delivering the workpieces, wherein the transfer of the workpieces from the multiple-stage vacuum lamination press into the multiple-stage laminator is realized through direct transfer from conveyor belt to conveyor belt, that is, no additional, intermediate transfer device is necessary. For this purpose, however, the multiple-stage vacuum lamination press and the multiple-stage laminator must be arranged one directly behind the other.

In the multiple-stage vacuum lamination press, according to the present invention the workpieces are first only pre-laminated, that is, the workpieces are placed under a vacuum for preventing the formation of bubbles, loaded with a pressure force, and then heated until the adhesive layers have been activated enough that the drawing out of gaseous components has been completed or has stopped due to the activation of the adhesive layer, and conversely, a penetration of air from the outside into the workpiece or between its layers—which would lead to the formation of air bubbles—is ruled out for when the vacuum chamber is filled with air. At this point in time in the lamination process, the workpieces are removed from the multiple-stage vacuum lamination press, because further processing, that is, curing of the adhesive layers, no longer has to be performed under a vacuum. This can be taken over, in fact, by the multiple-stage laminator, which exposes the workpieces to a temperature at or above the curing temperature of the adhesive layers, without the inclusion of vacuum chambers.

In particular, when the work cycle of the pre-lamination in the multiple-stage vacuum lamination press is shorter than the work cycle of the multiple-stage laminator for curing the adhesive layers, it is advantageous to connect more than one multiple-stage laminator behind the multiple-stage vacuum lamination press: for example, for the use of two multiple-stage laminators, the curing cycle can be twice as long as the work cycle of the multiple-stage vacuum lamination press, without having to take into account downtime of the multiple-stage vacuum lamination press.

The multiple-stage laminators are advantageously configured as presses, so that the curing of the adhesive layers can be performed not only under the effect of temperature, but also under the effect of pressure and so that the heat transfer from the heating plates to the workpieces is improved by contact pressure.

For realizing the lamination process, after the multiple-stage laminator, one or optionally also several multiple-stage cooling devices can be provided for cooling the workpieces to a temperature below the softening temperature of the adhesive layers. These cooling devices are advantageously constructed as presses, in order to cool the workpieces by contact pressure from cooling plates.

For the lamination of photovoltaic modules, highly adhesive bonding agents are used. In particular, when the flexible pressure member in the vacuum chambers of the multiple-stage vacuum lamination press are configured as usual as membranes made from, for example, silicone or rubber, which are each tensioned on a sealing frame provided in each stage of the multiple-stage vacuum lamination process, such highly adhesive bonding agents, however, are problematic. This is because adhesive residue on the membrane, which can make this membrane unusable or at least degrade the work result, can rarely be removed with justifiable expense from the membrane in multiple-stage lamination presses. Therefore, in the state of the art, separating films are used, which are arranged above and below the workpieces and which prevent the bonding of adhesive residue on heating plates and membranes of the multiple-stage vacuum lamination press. The use of separating films, however, requires, in turn, manual labor before and after the multiple-stage lamination press, so that this can rarely be connected with the fully automatic loading and removing of workpieces in a fully automatic processing line.

In this connection, the great advantage of the present invention is that it is possible to let the pre-lamination in the multiple-stage vacuum lamination press proceed under such low temperatures that the adhesive layers do indeed soften or begin to soften, but it does not liquefy so much that it must be ensured that adhesive residue reaches the membrane or the heating plate. Accordingly, separating films can be eliminated. The curing in the multiple-stage laminator connected afterward according to the invention is then indeed performed at the curing temperature of the adhesive layers, but in the multiple-stage laminators there is no soft elastic membrane that would have to be freed from adhesive residue, in order for its function not to be negatively affected.

Very generally, a great advantage of the procedure according to the invention and the corresponding device lies in that the temperature control in the individual stations, that is, the multiple-stage vacuum lamination press, the multiple-stage laminator, and optionally additional multiple-stage laminators, can be performed independently from each other, so that the interaction of heating and pressure can be controlled much more individually than when the entire lamination process is performed in a single multiple-stage vacuum lamination press. For example, in the multiple-stage vacuum lamination press, the target temperature can be selected much higher than the curing temperature, in order to guarantee quick heating of the workpieces, wherein, in this case the process should be interrupted at an early time accordingly. Conversely, however, the target temperature in the multiple-stage vacuum lamination press can be selected significantly lower than the curing temperature of the adhesive layers, so that the heating of the workpieces takes place more slowly—if this is desired—and at the same time the energy consumption is minimized.

Accordingly, the lamination process can be improved with respect to the aspect of the consumed energy and also with respect to an optimized temperature control in such a way that several multiple-stage laminators are connected one after the other, whose target temperatures vary, in particular, increase from laminator to laminator.

For controlling the heat introduction into the workpieces, in the multiple-stage vacuum lamination press and/or in the multiple-stage laminator and/or in the multiple-stage cooling press, pressure pads or cushions are placed under the workpieces and/or the workpieces are covered with such pads or cushions. Here, for its effect it is irrelevant whether such pressure pads or cushions are installed stationary in the machines or pass through the processing spaces loosely with the workpieces. For further influence of the temperature control in the workpiece, pressure pads or cushions can be used, which provide defined heat conducting properties and delay the heat transfer in a defined way accordingly.

Special advantages are produced in the scope of the present invention when the multiple-stage lamination press has a number of heating plates, which are arranged one above the other and which can move relative to each other, and a number of conveyor belts circulating around the heating plates each with an upper belt run and a lower belt run, without a membrane being provided as a flexible pressure member. Instead, here the vacuum chambers in each stage are bounded on one side by the upper heating plate and on the other side essentially by the upper belt run of the lower conveyor belt. Between the heating plates and the conveyor belts there are sealing elements, in particular, sealing frames, for sealing the vacuum chambers from the outside. The lower belt run of the upper conveyor belt then functions as a flexible pressure member, which separates a lower product half of the vacuum chamber from an upper pressure half of the same. Therefore, the membrane set in tension in a sealing frame is completely eliminated; its function is taken over also by the circulating conveyor belts. Because the conveyor belts are configured to circulate, cleaning of these belts outside of the press stages can be performed very easily, so that a separating film can also be eliminated. It is even possible to retrofit a conventional multiple-stage press into a multiple-stage vacuum lamination press configured in this way, in that sealing elements, in particular, sealing frames, are retrofitted for constructing vacuum chambers. This runs, in particular, directly on a heating plate, so that the associated conveyor belt runs over the sealing elements and thus both conveyor belts of adjacent heating plates run through the formed vacuum chamber.

For this purpose, the heating plates are advantageously provided with recesses or depressions, so that the sealing elements do not absolutely have to have the shape of a frame and nevertheless there is sufficient volume in the vacuum chambers. The upper heating plate can be provided on its bottom side with a recess or the lower heating plate can have recesses on its top side, or else both heating plates of one press stage can have recesses. The contours of the vacuum chambers thus can be machined into the top sides and/or bottom sides of the heating plates, including the necessary seals, as long as the conveyor belts themselves are not sealed from the surroundings of the chambers in the heating plates. Alternatively or additionally, fitted sealing frames are also possible, in order to form the vacuum chambers and their seals.

Additional advantages are produced in such a preferred construction of the multiple-stage vacuum lamination press, when the upper belt run of the conveyor belts have different material properties than the bottom belt run. This is because the upper belt run of the conveyor belts are used for the supported transport of the workpieces to be laminated, while the bottom belt runs are used at least when the conveyor belts execute a complete rotation about the heating plate for feeding and delivering workpieces only for realizing the conveyor belts and not directly for the transport of the workpieces. Accordingly, the bottom belt runs can have a softer and more elastic configuration and thus they can be optimized in their function as the pressure member during the lamination.

In such a different configuration of the upper belt run and the lower belt run of the conveyor belts, however, a complete rotation of the conveyor belts is necessary for feeding and delivering the workpieces, that is, one half is empty travel between the delivering and the feeding of workpieces. Nevertheless, in order to allow the connection of a multiple-stage vacuum lamination press and one or more multiple-stage laminators one behind the other according to the invention, initially the workpieces are delivered from the last multiple-stage laminator, then, in a second step, the workpieces are transferred from the preceding multiple-stage laminator or from the multiple-stage vacuum lamination press into the next multiple-stage vacuum laminator and new workpieces are fed only when complete into the multiple-stage vacuum lamination press, so that the half “empty” rotation begins at the end of the product line and proceeds forward to the beginning of the product line into the multiple-stage vacuum lamination press.

### BRIEF DESCRIPTION OF THE DRAWINGS

Embodiments of the present invention will be described and explained in more detail below with reference to the enclosed drawings. Shown are:

FIG. 1 is a schematic side partial diagram of an opened multiple-stage vacuum lamination press,

FIG. 2 is a schematic side partial diagram of a closed multiple-stage vacuum lamination press,

FIG. 3 is a schematic side diagram of a product line constructed according to the invention from a multiple-stage vacuum lamination press, a multiple-stage laminator, and a multiple-stage cooling device, in addition to loading and removing devices,

FIG. 4 is a diagram similar to FIG. 3, but during the work cycle, that is, for closed presses,

FIG. 5 is a partially complete side diagram of an opened multiple-stage vacuum lamination press,

FIG. 6 is a diagram similar to FIG. 5, but in the closed state,

FIG. 7 is a diagram of different parameters of the processed workpieces over time in a multiple-stage vacuum lamination press according to the state of the art,

FIG. 8 is a diagram similar to FIG. 7, but with a process divided according to the invention into one multiple-stage vacuum lamination press and two multiple-stage laminators connected afterwards,

FIG. 9 is a diagram as in FIG. 8, but with different initial conditions,

FIG. 10 is an expansion of FIGS. 8 and 9 by a multiple-stage cooling device station,

FIG. 11 is a schematic diagram of a production line constructed according to the invention,

FIG. 12 is a schematic diagram of a variation of a production line constructed according to the invention,

FIG. 13 is schematic side diagrams of workpieces to be laminated,

FIG. 14 is a schematic side partial diagram like FIG. 1, but a different construction,

FIG. 15 is a schematic side partial diagram like FIG. 1, but another construction.

### DETAILED DESCRIPTION OF THE PREFERRED EMBODIMENTS

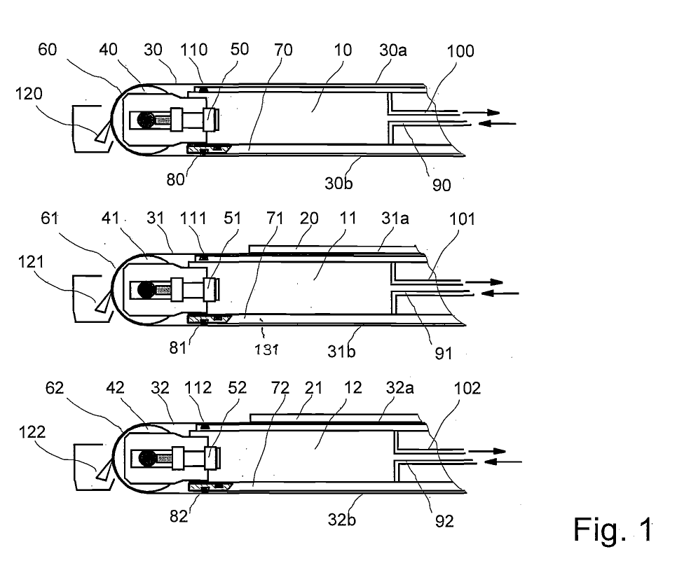

FIG. 1 shows a schematic side partial diagram of three heating plates 10, 11, 12 of a multiple-stage vacuum lamination press with a plurality of heating plates. The three heating plates 10, 11, 12 shown here form, between themselves, two press stages, in each of which a workpiece 20, 21 to be laminated is located.

A conveyor belt 30, 31, 32 circulates around the heating plate 10, 11, 12, indeed, around deflection rollers 40, 41, 42, which are each mounted by a piston-cylinder unit 50, 51, 52 on the end faces of the heating plates 10, 11, 12 and by moving against these end sides, the conveyor belts 30, 31, 32 can be relieved of stress and vice versa. The conveyor belts 30, 31, 32 each include an upper belt run 30a, 31a, 32a constructed as a transport belt and a lower belt run 30b, 31b, 32b, which has a more elastic and wider construction, and these two parts are connected to each other with two detachable belt connectors 60, 61, 62 (of which, in this diagram naturally only one is visible).

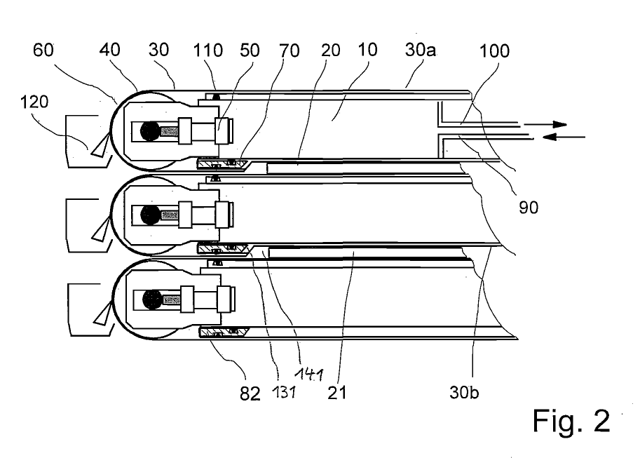

For forming the vacuum chambers in the individual stages of the multiple-stage vacuum lamination press shown partially, between the upper belt run 30a, 31a, 32a of the conveyor belts 30, 31, 32 and the top sides of the heating plates 10, 11, 12, sealing frames 110, 111, 112 are attached, while between the lower belt run 30b, 31b, 32b and the bottom sides of the heating plates 10, 11, 12, top sealing frames 80, 81, 82 are attached, which contact the lower sealing frame 110, 111, 112 when the press is closed (FIG. 2). The gas-tight vacuum chambers formed in this way are each divided by a lower belt run 30b, 31b, 32b into a product half 141 and a pressure half 131, wherein the workpieces 20, 21 come to lie underneath the bottom belt run 30b, 31b, 32b in the product halves 141 of the vacuum chambers.

The top sides of the heating plates 10, 11, 12 bordering the product halves have a smooth construction in the presently shown embodiment and are provided with here only symbolically shown suction openings 100, 101, 102, in order to be able to evacuate the product space between the upper belt run 31a of a lower conveyor belt 31 and the lower belt run 30b of an upper conveyor belt 30. For this purpose, the upper belt runs 30a, 31a, 32a of the lower conveyor belts 30, 31, 32 have a narrower construction than the lower belt runs 30b, 31b, 32b, so that laterally next to the upper belt sections 30a, 31a, 32a, a connection is given between the product spaces and the top sides of the heating plates 10, 11, 12 within the sealing frames 80, 81, 82, 110, 111, 112 and the product halves 141 of the vacuum chambers are formed. Accordingly, for example, an evacuation of the product half 141 and especially the product space can be performed through the heating plate 12, for example, by a suction opening 102, by which a formation of bubbles is prevented during lamination.

In the bottom sides of the heating plates 10, 11, 12, recesses 70, 71, 72 are machined, so that in connection with the sealing frames 80, 81, 82 above the lower belt run 30b, 31b, 32b, a pressure half 131 of the vacuum chambers is formed. This pressure half can be loaded with compressed gas by symbolically shown pressure lines 90, 91, 92 or, in the simplest case, also only filled with air, so that the lower belt runs 30b, 31b, 32b press tightly against the workpieces 20, 21 and press these workpieces against the heating plates 11, 12 due to the vacuum established in the product half, optionally supported by an excess pressure established in the pressure half. The lower belt runs 30b, 31b, 32b of the conveyor belts are kept relatively wide, so that they cover the sealing frames 80, 81, 82 all around and in a gas-tight manner.

The piston cylinder units 50, 51, 52 on the end faces of the heating plates 10, 11, 12 allow the tension of the conveyor belts and thus, in particular, the tension of the lower belt run 30b, 31b, 32b to change. For example, when a high conveyor belt tension is set when the workpieces 20, 21 are fed or delivered, whereas, when the press is closed and, in particular, during the lamination process, with evacuation and pressurization of the vacuum chambers, a release of tension in the conveyor belts 30, 31, 32 is advantageous. The workpieces 20, 21 then lie loosely on the top sides of the heating plates 11, 12 due to the reduced tension of the upper belt run 31a, 32a, while the lower belt run 30b, 31b acts against deformation by the vacuum and optionally excess pressure of less resistance.

On the deflection rollers 40, 41, 42 of each conveyor belt 30, 31, 32 there is also a cleaning device 120, 121, 122, for example, a rotating cleaning brush or—as shown here—a doctor blade. When the workpieces 20, 21 are discharged after the opening of the multiple-stage vacuum lamination press, the lower belt run 30b, 31b, 32b of the conveyor belts 30, 31, 32 move past the cleaning devices 120, 121, 122 and are freed there from any adhesive residue. When the workpieces 20, 21 are discharged, the lower belt runs 30b, 31b, 32b each lie on the top side of the heating plates 10, 11, 12, so that again a half rotation of the conveyor belts 30, 31, 32 as empty travel is necessary, in order to allow the entry of other workpieces. Here, the upper belt run 30a, 31a, 32a of the conveyor belts 30, 31, 32 then also move past the cleaning devices 120, 121, 122, so that these are also freed from any adhesive residue.

In FIG. 2, the multiple-stage vacuum lamination press from FIG. 1 is shown in a similar partial diagram—again only symbolically—but in the closed state. As is clarified with reference to this drawing, the lower belt run 30b, 31b, 32b of the conveyor belts 30, 31, 32 lie on the upper belt run 30a, 31a, 32a of the underlying conveyor belts or on the intermediate workpieces 20, 21 when the multiple-stage vacuum lamination press. Simultaneously, the sealing elements 80, 81, 82, on one side, and 110, 111, 112 on the other side are sealed all around with the intermediate conveyor belts 30, 31, 32, in order to form a vacuum chamber in each press stage. These vacuum chambers are divided by the lower belt run 30b, 31b, 32b of the conveyor belts in a gas-tight way, namely, into an upper pressure half 131 and a lower product half 141. After the product half 141 of the vacuum chambers has been evacuated by the lines 100, 101, 102, the pressure halves 131 of the vacuum chambers are pressurized with compressed air by the lines 90, 91, 92. The Teflon-coated, less elastic, thin lower belt run 30b of a conveyor belt 30 takes over, in the present embodiment, thus, instead of an elastic membrane, the function of the pressure member during the pre-lamination of the workpiece 20.

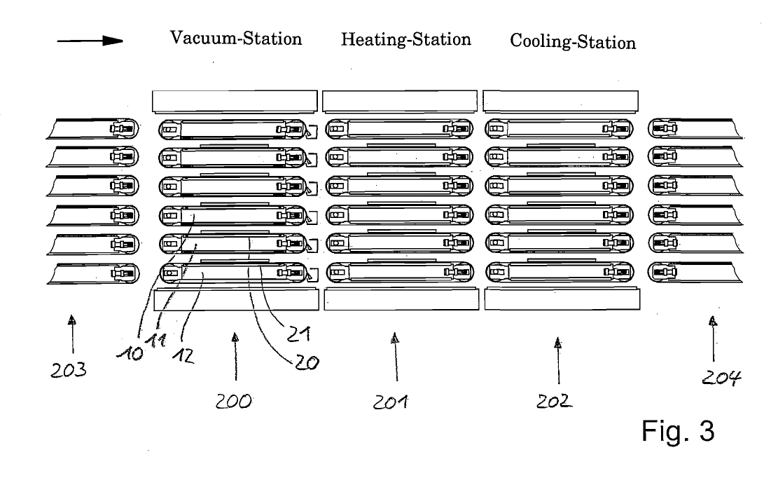

In a schematic side diagram, FIG. 3 shows an embodiment for a device according to the invention for laminating photovoltaic modules, wherein this device is divided into three stations, namely a multiple-stage vacuum lamination press 200, a multiple-stage laminator 201, and a multiple-stage cooling device 202. Before the multiple-stage vacuum lamination press 200 and after the multiple-stage cooling device 202 there are multiple-stage feeding or discharging devices 203, 204, in order to feed the workpieces 20, 21 into the multiple-stage vacuum lamination press 200 or to discharge them from the multiple-stage cooling device 202.

Both the multiple-stage vacuum lamination press 200 and also the multiple-stage laminator 201 and the multiple-stage cooling device 202 are constructed as multiple-stage presses, wherein each heating or cooling plate is provided with a circulating conveyor belt. These circulating conveyor belts form the transfer device for transferring the workpieces from the multiple-stage vacuum lamination press into the multiple-stage laminator and the multiple-stage cooling device, wherein the workpieces 20, 21 are transferred directly, without the intermediate connection of a separate transfer device, from one station to the next. Accordingly, the three shown stations are arranged directly one behind the other in a space-saving way. Because, as described above, in the multiple-stage vacuum lamination press, the lower belt runs of the conveyor belts have a different construction than the upper belt runs of the conveyor belts, a half rotation of the conveyor belt as empty travel is necessary, in order to be able to feed new workpieces again after the delivery of the workpieces 20, 21. In the multiple-stage laminator 201 and in the multiple-stage cooling device 202, it can also be provided to perform such an empty travel, for example, in order to clean the conveyor belts. Accordingly, for the device shown in FIG. 3, at the end of each work cycle, initially a delivery of the workpiece from the multiple-stage cooling device 202 into the unloading device 204 is performed, the empty travel of the multiple-stage cooling device 202 is performed, and only then the transfer of the workpieces from the multiple-stage laminator 201 into the multiple-stage cooling device 202 is started. Then the optionally provided empty travel of the multiple-stage laminator 201 is performed before the pre-laminated workpieces 20, 21 are fed from the multiple-stage vacuum lamination press and are transferred into the multiple-stage laminator 201. After, in turn, the necessary empty travel of the multiple-stage vacuum lamination press 200, finally new workpieces are fed into the multiple-stage vacuum lamination press from the loading device 203. This procedure is thus equivalent to a void or hole transport of electrical charge carriers in a semiconductor crystal.

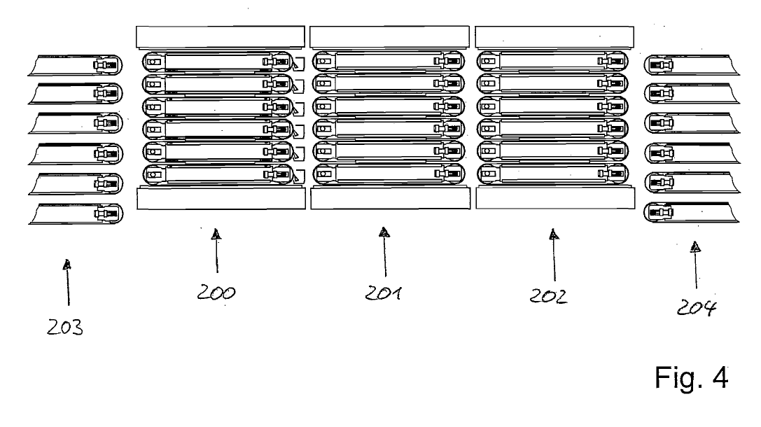

FIG. 4 is a diagram of the same embodiment slightly modified relative to FIG. 3, wherein here both the multiple-stage vacuum lamination press 200 and also the multiple-stage laminator 201 and the multiple-stage cooling device 202 are closed. Thus, it involves the diagram of the work cycle of the device with a cycle operation. At this point it should be noted that a cycle operation of the device according to the invention is definitely preferred, but not absolutely necessary. It is also not absolutely necessary within the scope of the present invention that all of the press stages of one of the presses are opened and closed simultaneously, instead, the press stages can be operated, in principle, also group by group or individually.

According to the invention, the workpieces 20, 21 are exposed to a vacuum only in the multiple-stage vacuum lamination press 200. The multiple-stage laminator 201 and the multiple-stage cooling device 202 are each constructed as presses, in order to improve the heat transfer, on one side, to the heating plates and, on the other side, to the cooling plates, by contact pressure. Pressurization in the multiple-stage laminator 201 simultaneously supports the curing of the adhesive layers in the workpieces.

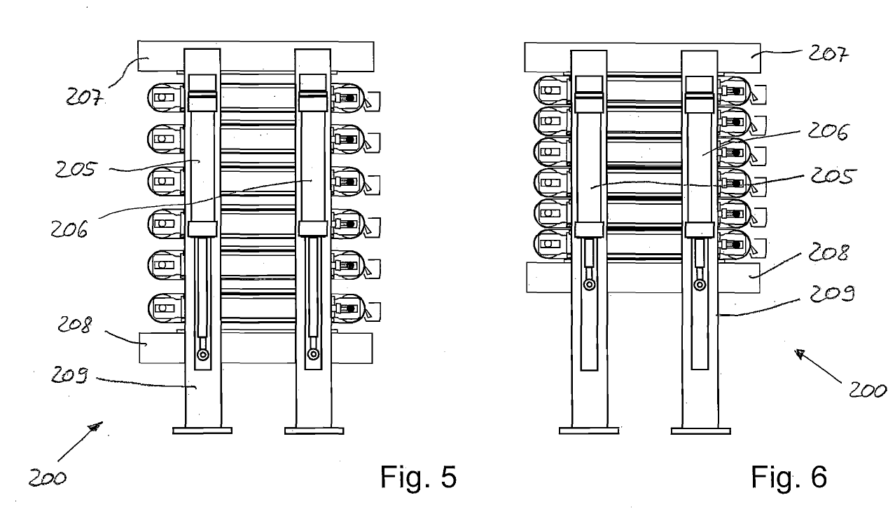

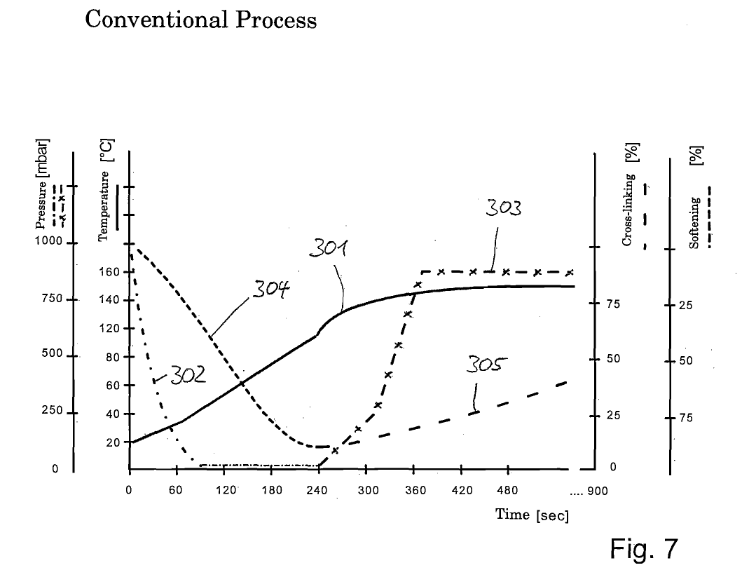

FIGS. 5 and 6 show a complete diagram of the multiple-stage vacuum lamination press 200 in the opened (FIG. 5) and closed (FIG. 6) state. Using two hydraulic cylinders 205, 206, which are each mounted, on one side, to an upper pressure bar 207 and a lower pressure bar 208, which can move relative to a frame 209, the upper and lower pressure bars 207, 208 can be moved relative to each other, in order to close and open the press. Accordingly, in the present invention all of the press stages are opened and closed sequentially.

FIG. 7 shows a diagram of different initial conditions of a conventional process in a multiple-stage vacuum lamination press. According to the state of the art, here the workpieces are processed up to the curing of the adhesive layers in the multiple-stage vacuum lamination press. The solid line 301 shows the temperature in the workpiece, while the dash-dot line 302 in the first half of the diagram shows the air pressure in the product half of the vacuum chamber and in the second half as line 303 the contact pressure acting on the workpiece. In the case of line 302, values are plotted directly as gas pressure in mbar and in the case of line 303, equivalent to the gas pressure in mbar. As a result of these initial conditions (pressure and temperature), the lines 304 and 305 shown with dashed lines are produced, wherein the line 304 shows the softening of the adhesive layers in %, while line 305 shows the degree of cross-linking of the adhesive layers, here a cross-linking bonding agent.

As can be seen with reference to this diagram, the temperature of the workpieces increases along the line 301 beginning from room temperature (20° C.) up to the target temperature (ca. 150° C.), wherein the rise of line 301 depends on the heat transfer between the heating plates and the workpieces.

With reference to the sharply falling line 302, it becomes clear that the product half of the vacuum chamber is evacuated as quickly as possible before the workpieces are heated significantly. Already at a workpiece temperature below 50° C., the pressure in the vacuum chamber falls almost to 5 mbar, so that a formation of bubbles in the adhesive layers is prevented. The softening (line 304) of the adhesive layers increases according to the increase of the workpiece temperature 301. When a temperature of approximately 120° C. is reached and a degree of softening of greater than 80%, the pressure half of the vacuum chamber is filled with air, so that the pressure member, which separates the pressure half from the (further evacuated) product half of the vacuum chamber, exerts an increasing contact pressure on the workpiece. This is clarified with line 303. In the present case, the pressure half of the vacuum chamber is merely filled with air, but not loaded with additional pressure, so that the resulting contact pressure (line 303) acting on the workpiece remains slightly below atmospheric pressure. With increasing pressure (303) and increasing temperature (301), the degree of cross-linking (305) of the adhesive layers increases, so that curing is performed. The contact pressure of the workpiece against the heating plate produced by filling the pressure half of the vacuum chamber with air naturally increases the heat transfer into the workpiece, by which the temperature (301) rises more quickly until it asymptotically approaches the target temperature.

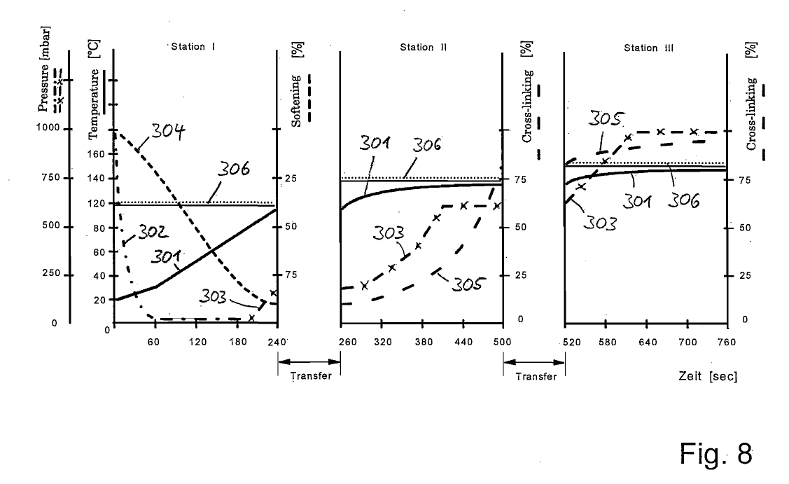

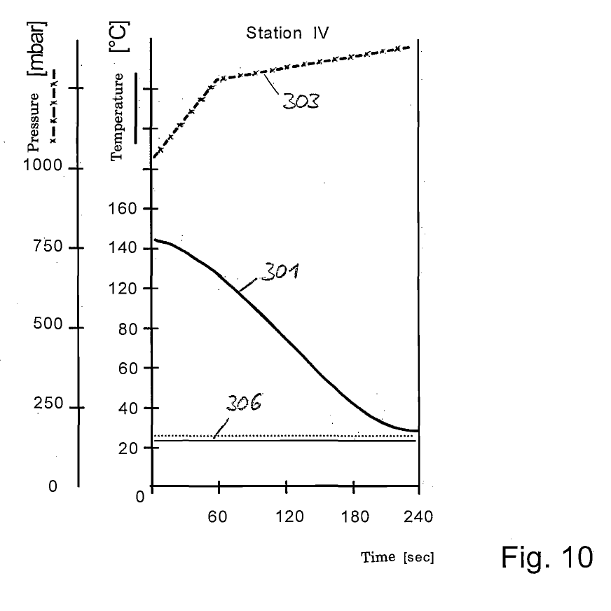

In contrast, FIG. 8 shows a first example for a process divided according to the invention, wherein station I symbolizes the multiple-stage vacuum lamination press, station II symbolizes the multiple-stage laminator, and station III symbolizes a second multiple-stage laminator. The multiple-stage cooling device is represented as station IV in FIG. 10.

As becomes clear with reference to FIG. 8, here in the station I, the pressure in the product half of the vacuum chamber (line 302) also falls as rapidly as possible, in order to prevent the formation of bubbles in the adhesive layers. Because the process is distributed according to the invention onto several stations, however, the target temperature does not have to be at or above the curing temperature of the adhesive layers as in the conventional process, but instead can be selected lower. In the present case, the target temperature lies at 120° C., which is clarified by a double line 306.

Due to the reduced target temperature 306, the workpiece heats up more slowly, which results in a flatter temperature curve 301. Accordingly, the softening 304 of the adhesive layers is also realized more slowly, so that the evacuation of the product space (line 302) can still be completed before significant softening of the adhesive layers.

The curing of the adhesive layers is then performed in stages in stations II and III, that is, in two multiple-stage laminators connected one after the other. In the first multiple-stage laminator (station II), the target temperature 306 continues to lie at a reduced level relative to the curing temperature, in the present case at ca. 140° C., so that the temperature 301 approaches the target temperature 150° C. only slowly and only first in the second stage in station III.

Because the multiple-stage laminators of stations II and III are constructed as heating presses, the contact pressure acting on the workpieces, as line 303 shows, can be controlled for optimum cross-linking (line 305). Through initially only one-sided airing of the pressure half of the vacuum chamber in station I and only then two-sided airing for opening the multiple-stage vacuum lamination press, incidentally, already in station I a certain contact pressure—line 303—is exerted on the workpiece.

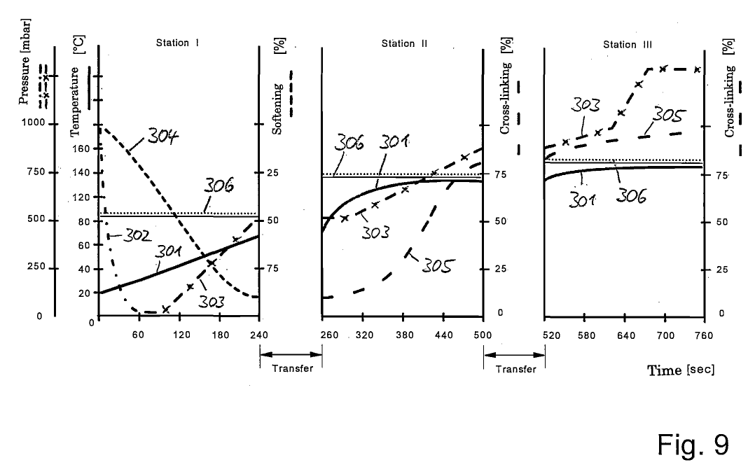

In FIG. 9, another example of the process control in the method according to the invention is shown, which corresponds to the example shown in FIG. 8, but which is configured differently with respect to the processing parameters. Here, in particular, in station III a higher contact pressure on the workpieces is applied, while the target temperatures are selected as in the example according to FIG. 8. Also, exposing the workpieces to a contact pressure in station I for better prevention of the formation of bubbles in the pre-lamination is here performed at an earlier stage and to a greater degree.

FIG. 10 completes both FIG. 8 and also FIG. 9 with a station IV, which symbolizes a multiple-stage cooling device. Accordingly, here the target temperature 306 lies at room temperature and the profile of the workpiece temperature 301 is falling from the curing temperature of nearly 150° C. to room temperature. The heat transfer from the cooling plates (306) to the workpieces (301) is improved by a contact pressure 303, which is why the multiple-stage cooling device (station IV) is equipped as a multiple-stage press with cooling plates.

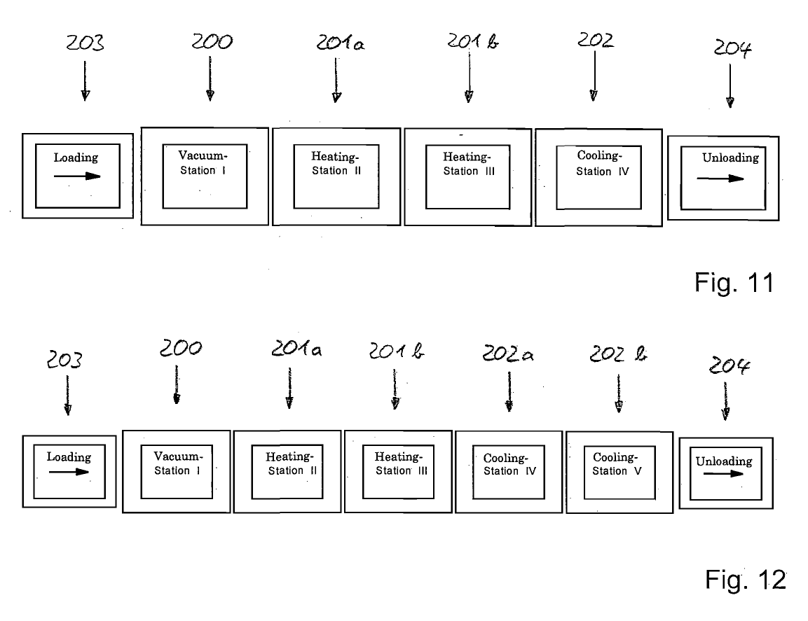

Finally, FIGS. 11 and 12 show schematically two different embodiments for a device according to the invention, wherein, in the embodiment according to FIG. 11 of a multiple-stage vacuum lamination press 200 (vacuum station I), two multiple-stage laminators 201a and 201b (heating stations II and III) and also one multiple-stage cooling device 202 (cooling station IV) are connected one after the other. For loading the multiple-stage vacuum lamination press 200, a loading device 203 is provided, while for unloading the multiple-stage cooling device 202, an unloading device 204 is connected at the output.

With the production line shown in FIG. 11, the processes shown in FIGS. 8 and 10 or 9 and 10 can be performed. The production line shown in FIG. 12 differs here merely in that, instead of a multiple-stage cooling device 202, two multiple-stage cooling devices 202a and 202b are provided, for example, for adapting the work cycle to the multiple-stage vacuum lamination press 200, whose work cycle is optionally too short to allow cooling of the final laminated workpieces in a single cooling station.

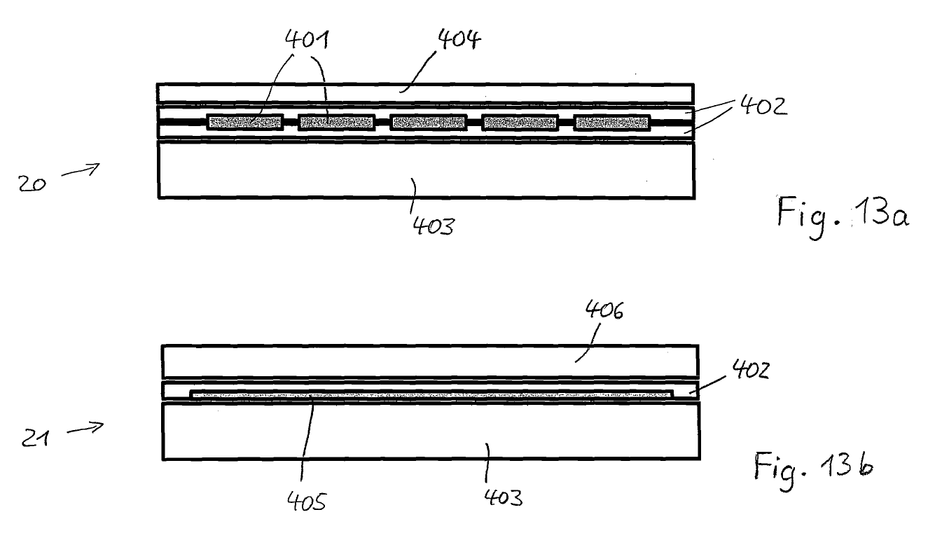

In FIG. 13a, an example for a workpiece 20 is shown, which is to be laminated with the method according to the invention. This involves a silicon solar cell module with a number of silicon solar cells 401, which are embedded between two adhesive films 402. The front side of the module is formed by a substrate glass 403, while the back side of the module is placed on a back side film 404. As can be directly seen with reference to this diagram, the shown workpiece 20 is laminated by the method according to the invention in such a way that the substrate glass 403, the silicon solar cells 401, and the back side film 404 are connected to each other in a permanent and weatherproof way due to the cross-linking adhesive contained in the adhesive films 402.

FIG. 13b shows another example for a workpiece 21 to be laminated, which is constructed, in turn, as a photovoltaic module, but includes a thin-film solar cell 405, which is embedded between a substrate glass 403 and a back side glass 406 in an adhesive film 402. After the lamination process, the substrate glass 403 and the back side glass 406 are connected to each other in a permanent and weatherproof way with the intermediate thin-film solar cell 405.

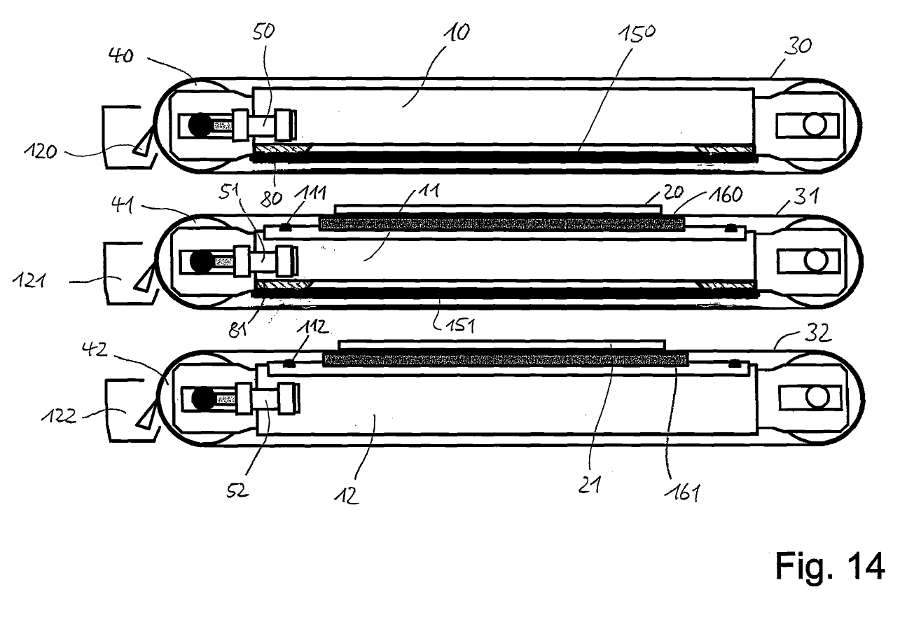

FIG. 14 shows, like FIG. 1, a schematic side partial diagram of three heating plates 10, 11, 12 of a multiple-stage vacuum lamination press, which form, in turn, two press stages each with a workpiece 20, 21 to be laminated. A conveyor belt 30, 31, 32 circulates around the heating plates 10, 11, 12, respectively, and that is, in turn, around deflection rollers 40, 41, 42, which are each mounted by a piston cylinder unit 50, 51, 52 on the end faces of the heating plates 10, 11, 12 and the conveyor belts 30, 31, 32 can be relieved of tension by moving against these end faces and vice versa. A cleaning device 120, 121, 122 is arranged on the deflection rollers 40, 41, 42 of each conveyor belt 30, 31, 32.

For forming the vacuum chambers in the individual stages of the partially shown multiple-stage vacuum lamination press, in turn, lower sealing frames 111, 112, and also upper sealing frames 80, 81 are provided. In contrast to the embodiment shown in FIG. 1, here membranes 150, 151, which divide the gas-tight vacuum chambers formed in a closed press into a product half and a pressure half, are mounted on the upper sealing frames 80, 81. The membranes 150, 151 take over, in a conventional way, the function of the lower belt run 30b, 31b, 32b of the embodiment from FIG. 1, so that, incidentally, reference can be made to the function described for FIG. 1 and the state of the art for vacuum lamination presses.

In FIG. 14, finally it is also provided as an additional modification to arrange a pressure pad 160, 161 between the heating plates 11, 12 and the workpieces 20, 21, in order to compensate for any unevenness or tolerances in the parallelism of the workpieces 20, 21.

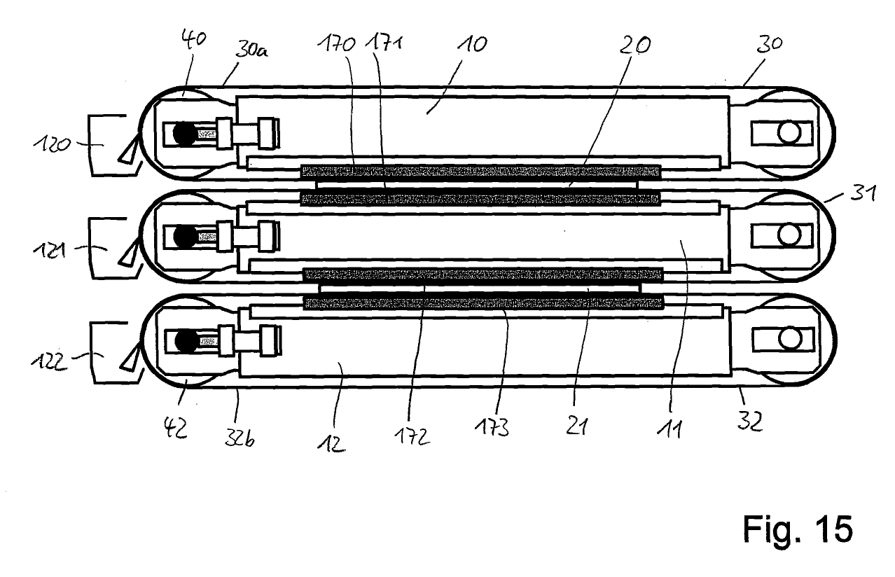

In FIG. 15, another modification of the embodiment of a device according to the invention shown in FIGS. 1 and 2 is shown, wherein the modification consists in that above and below the workpieces 20, 21, a cushion 170, 171, 172, 173 is attached, which is used not only for better pressure distribution, but also provided defined heat conducting properties and influences the heat transfer from the heating plates 10, 11, 12 to the workpieces 20, 21 in a defined way. For the remaining features of the embodiment illustrated here, refer to the preceding figure descriptions, because functionally equivalent elements are provided with identical reference symbols.

1. Method for laminating essentially plate-shaped workpieces with at least one adhesive layer that can be heat activated and cured under the effect of pressure and heat, the method comprising:
inserting a number of workpieces (20, 21) into a multiple-stage vacuum lamination press (200), in which the workpieces (20, 21) are laminated under the effect of heat in press stages that include a vacuum chamber divided by a flexible pressure member (30b, 31b, 32b, 150, 151) into a product half (141) and a pressure half (131),
evacuating the product half (141) of the vacuum chamber, in which at least one workpiece (20, 21) is arranged, and pressing the workpiece (20, 21) with the pressure member (30b, 31b, 32b, 150, 151) directly or indirectly against a bottom side of the vacuum chamber by a resulting low pressure and/or by an additional pressurization of the pressure half (131) of the vacuum chamber, which is arranged on a side of the pressure member (30b, 31b, 32b, 150, 151) facing away from the workpiece (20, 21),
interrupting the lamination process by opening of the multiple-stage vacuum lamination press (200) and transferring the pre-laminated workpieces (20, 21) into a multiple-stage laminator (201), and
exposing the workpieces (20, 21) in the multiple-stage laminator (201) to a temperature at or above a curing temperature of adhesive layers (402) of the workpieces.

2. Method according to claim 1, wherein
as the flexible pressure member, membranes (150, 151) are used, which are each tensioned on a sealing frame (80, 81) provided in each of the stages of the multiple-stage vacuum lamination press (200).

3. Method according to claim 1, wherein
the multiple-stage vacuum lamination press (200) used contains a number of heating plates (10, 11, 12), a circulating conveyor belt (30, 31, 32) with an upper belt run (30a, 31a, 32a) and a lower belt run (30b, 31b, 32b) passes around each of the heating plates (10, 11, 12), and that the lower belt run (30b, 31b, 32b) of the conveyor belts (30, 31, 32) is used as the flexible pressure member in each of the stages.

4. Method according to claim 3, wherein
the conveyor belts (30, 31, 32) are used, in which the upper belt runs (30a, 31a, 32a) are configured differently than the lower belt runs (30b, 31b, 32b).

5. Method according to claim 4, further comprising:
for loading and unloading the multiple-stage vacuum lamination press (200) and the multiple-stage laminator (201), initially delivering the workpieces (20, 21) from the multi-stage laminator, then in a second step transferring the workpieces (20, 21) from the multiple-stage vacuum lamination press (200) into the multiple-stage laminator (201), and then in a third step feeding new workpieces (20, 21) into the multiple-stage vacuum lamination press (200).

6. Method according to claim 1, further comprising
transferring the workpieces (20, 21) from the multiple-stage laminator (201) into a multiple-stage cooling device (202) for cooling the workpieces (20, 21) to a temperature below a softening temperature of the adhesive layers (402).

7. Method according to claim 6, further comprising
positioning pressure pads (160, 161) or cushions (170, 171, 172, 173) in the multiple-stage vacuum lamination press (200) and/or in the multiple-stage laminator (201) and/or in the multiple-stage cooling device (202) between the workpieces (20, 21) and corresponding heat-exchange surfaces.

8. Method according to claim 1, further comprising
positioning pressure pads (160, 161) or cushions (170, 171, 172, 173) each with defined heat conducting properties for influencing a time heat effect on an adhesive layer (402) of the workpieces (20, 21) in the multiple-stage vacuum lamination press (200) and/or in the multiple-stage laminator (201) and/or in the multiple-stage cooling device (202), between the workpieces (20, 21) and corresponding heat exchange surfaces.

9. Method according to claim 1, wherein
a process temperature in the multiple-stage vacuum lamination press (200) is controlled independent of the multiple-stage laminator (201), and a target temperature is set higher or lower.

10. Method according to claim 9, further comprising
controlling the heat effect on the workpieces (20, 21) in the multiple-stage vacuum lamination press (200) so that the adhesive layers (402) are softened and the lamination process begins such that a temperature in the adhesive layers (402), however, remains below the curing temperature.

11. Method according to claim 10, wherein
for controlling the heat effect in the multiple-stage vacuum lamination press (200), the target temperature is selected low or the process is stopped at an early stage.

12. Method according to claim 9, wherein
several multiple-stage laminators (201) connected one after the other are used, having target temperatures that vary from one of the laminators to a next of the laminators.

13. Device for laminating essentially plate-shaped workpieces provided with at least one adhesive layer that can be activated and cured by heat under the effect of pressure and heat, the device comprising a multiple-stage vacuum lamination press (200) with several press stages, each of the press stages includes a vacuum chamber divided by a flexible pressure member (30b, 31b, 32b, 150, 151) into a product half (141) and a pressure half (131), the product half (141) is provided for receiving at least one workpiece (20, 21) and can be evacuated, and the pressure half (131) is pressurizable, the flexible pressure member (30b, 31b, 32b, 150, 151) is configured and arranged in such a way that it presses the workpiece (20, 21) directly or indirectly against a bottom side of the vacuum chamber due to a pressure difference in the vacuum chamber provided through evacuation of the product half (141) and/or through an additional pressurization of the product half (131), at least one multiple-stage laminator (201) with a number of laminator stages is connected after the multiple-stage vacuum lamination press (200), wherein, in the laminators, the workpieces (20, 21) are exposed to a temperature at or above a curing temperature of adhesive layers (402) of the workpieces, and a transfer device (30, 31, 32) is provided for transferring the workpieces (20, 21) from the multiple-stage vacuum lamination press (200) into the multiple-stage laminator (201).

14. Device according to claim 13, further comprising
at least one multiple-stage cooling device (202) for cooling the workpieces (20, 21) to a temperature below a softening temperature of the adhesive layers (402) is connected after the multiple-stage laminator (201), and a transfer device is provided for transferring the workpieces (20, 21) from the multiple-stage laminator (201) into the multiple-stage cooling device (202).

15. Device according to claim 13, wherein
the flexible pressure member in the vacuum chambers of the multiple-stage vacuum lamination press (200) comprise elastic membranes (150, 151), which are each tensioned on a sealing frame (80, 81) provided in each of the stages of the multiple-stage vacuum lamination press (200).

16. Device according to claim 13, wherein
the multiple-stage vacuum lamination press (200) includes a number of heating plates (10, 11, 12), a circulating conveyor belt (30, 31, 32) with an upper belt run (30a, 31a, 32a) and a lower belt run (30b, 31b, 32b) extends around each of the heating plates, and each of the lower belt runs (30b, 31b, 32b) of the conveyor belts (30, 31, 32) functions as the flexible pressure member in each of the stages.

17. Device according to claim 16, wherein
the upper belt run (30a, 31a, 32a) and the lower belt run (30b, 31b, 32b) of each of the conveyor belts (30, 31, 32) are each configured differently.

18. Device according to claim 14, wherein
pressure pads (160, 161) and/or cushions (170, 171, 172, 173) are located in a position adapted to be under the workpieces (20, 21) and/or pressure pads (160, 161) or cushions (170, 171, 172, 173) are located in a position adapted to be on top of the workpieces (20, 21) in the multiple-stage vacuum lamination press (200) and/or in the multiple-stage laminator (201) and/or in the multiple-stage cooling device (202).

19. Device according to claim 18, wherein
the pressure pads (160, 161) or cushions (170, 171, 172, 173) influence a time heat effect on the adhesive layer (402) of the workpieces (20, 21) and each have defined heat conducting properties.

20. Device according to claim 13, wherein
a controller is provided that controls the processing temperature in the multiple-stage vacuum lamination press (200) independent of the multiple-stage laminator (201) to set a target temperature higher or lower.

21. Device according to claim 20, wherein
a controller controls the heat effect on the workpieces (20, 21) in the multiple-stage vacuum lamination press (200) so the adhesive layers (402) are softened and the lamination process begins, but a temperature in the adhesive layers (402) remains below a curing temperature.

22. Device according to claim 21, wherein
several multiple-stage laminators (201a, 201b) are connected one behind the other.
